(19) United States
(12) Patent Application Publication
(10) Pub. No.: US 2007/0170619 A1
(43) Pub. Date: Jul. 26, 2007

(54) Method for continuous production of fibre-reinforced plastic plates

(76) Inventor: Kurt Behre, Osnabruck (DE)

Correspondence Address: BACHMAN & LAPOINTE, P.C., 900 CHAPEL STREET, SUITE 1201, NEW HAVEN, CT, 06510, US

(21) Appl. No.: 10/590,500

(22) PCT Filed: Feb. 25, 2005
(86) PCT No.: PCT/EP05/01973

§ 371 Date: Aug. 24, 2006

(30) Foreign Application Priority Data
Mar. 5, 2004 (EP) 04405133.2

(51) Int. Cl. B29C 43/22

(52) U.S. Cl. 264/324; 425/327

(57) ABSTRACT

A method for the continuous production of a thermoplastic plate material which is reinforced with a flat-shaped fibrous structure. The method is characterized in that a first web-shaped fibrous structure is guided to a fibre laying device, and one or several additional web-shaped fibrous structures are arranged inline over the first fibrous structure by means of fibre guiding units. One or several matrix guiding units, which are mounted upstream of or downstream from the fibre guiding units, are used to guide a matrix starting material to free layers of the fibrous structure, in particular, a reactive starting material such as cyclic oligomers of PBT, and the multi-layered fibrous web, which is covered one or several times with intermediate layers of matrix starting material, exiting from the fibre laying device, is guided to a through press wherein the matrix starting material is transformed into a low-viscous liquid under the effects of heat and/or pressure. The multi-layered fibrous web is pressed into a plate-shaped plastic material made of PBT (polybutylene terephthalate) by impregnating fibrous structures.

### CROSS REFERENCE TO RELATED APPLICATIONS

This case is the U.S. national phase of International Application No. PCT/EP2005/001973 filed Feb. 25, 2005 which claims priority of European Application No. 04405133.2 filed Mar. 5, 2004.

### BACKGROUND OF THE INVENTION

The invention concerns a method for the continuous production of fibre-reinforced plastics plates with a thermoplastics matrix, and particularly a method for continuous production of a planar thermoplastic plate material reinforced with flat fibre structures, characterised in that a first web-like fibre structure is supplied to a fibre laying device, by means of in-line fibre feed units one or more further web-like fibre structures are arranged over the first fibre structure, by means of one or more matrix feed units connected before or after the fibre feed units a matrix starting material is supplied to exposed layers of fibre structures, and the multilayer fibre web emerging from the fibre laying device and coated one or more times with intermediate layers of matrix starting material is supplied to a continuous press in which the matrix starting material is transformed under the effect of heat and/or pressure into a low viscosity fluid and the multilayer fibre web under impregnation of the fibre structure is pressed into a plate-like plastics material.

Previously, it was difficult to produce thermoplastics plastics matrix systems in a continuous method for the production of fibre-reinforced plastic plates. The difficulty in processing thermoplastic plastics matrix systems lies amongst others in the provision of a suitable reactive starting material which is not only chemically stable but can also be transformed into a low viscosity state for further processing. In addition, no suitable method is known for continuous production of plate material with a thermoplastic plastics matrix system.

Thus previously the production of fibre-reinforced plate material with thermoplastic plastics matrix has been restricted to discontinuous and correspondingly costly processes.

The object of the present invention is to propose a continuous method for the production of plate material reinforced with fibre structures and with a thermoplastic plastics matrix.

### SUMMARY OF THE INVENTION

According to the invention the object is achieved by a method for continuous production of a planar thermoplastic plate material reinforced with flat fibre structures, characterised in that a first web-like fibre structure is supplied to a fibre laying device, by means of in-line fibre feed units one or more further web-like fibre structures are arranged over the first fibre structure, by means of one or more matrix feed units connected before or after the fibre feed units a matrix starting material is supplied to exposed layers of fibre structures, and the multilayer fibre web emerging from the fibre laying device and coated one or more times with intermediate layers of matrix starting material is supplied to a continuous press in which the matrix starting material is transformed under the effect of heat and/or pressure into a low viscosity fluid and the multilayer fibre web under impregnation of the fibre structure is pressed into a plate-like plastics material.

### BRIEF DESCRIPTION OF THE DRAWINGS

The invention is explained in more detail below with reference to the enclosed drawing as an example. This shows:

FIG. 1a, b: a device for performance of the method according to the invention;

FIG. 2 an exemplary arrangement of a fibre structure according to the method in the invention;

FIG. 3 an exemplary arrangement of the powder scatterer within the device;

FIG. 4 a cross-section through A-A according to FIG. 3 with exemplary arrangement of the fibre structure.

### DETAILED DESCRIPTION

The definitions of the terms below are valid for the present text:

Reactive starting material in the definition comprises amongst others cyclic or macrocyclic oligomers of polyester, in particular PBT (known as CPBT) which are mixed with a polymerisation catalyst. Furthermore, the reactive starting material also comprises blends (alloys) containing the above substances which for example after completion of the polymerisation lead to a PBT blend (PBT plastic alloy). Reactive starting materials of the said type for production of polyester or PBT plastics are described in more detail in U.S. Pat. No. 6,369,157, the content of which is hereby part of the disclosure. A particularly suitable reactive starting material with cyclic oligomers is sold under the name CBT™ (Cyclic Butylene Terephthalate) by the company Cyclics or Dow Chemical Company.

The polymerisation catalyst can for example be a zinc catalyst or other suitable catalyst. The reactive starting material in the definition is characterised in particular in that for processing, it can be transformed into a low viscosity melt which thoroughly impregnates the fibre structure.

Polyesters according to the definition comprise amongst others plastics such as PET (polyethylene terephthalate) and associated plastics alloys and in particular PBT (polybutylene terephthalate) or PBT blends also known as PBT plastics alloys.

Fibre structures according to the invention are planar structures and comprise amongst others textile structures e.g. fleeces, non-wovens, non-mesh forming systems such as weaves, uni- or bidirectional lays, braids or mats etc. or for example mesh-forming systems such as knitted fabrics and knitted structures.

The fibres of the fibre structure contain by definition long fibres with fibre length of e.g. 3-150 mm, or endless fibres. They are processed for example in the form of rovings into fibre structures.

The fibres can be glass fibres, aramid fibres, carbon fibres, plastic fibres, natural fibres or mixtures thereof. Plastics fibres can in particular be polyester fibres e.g. PET, PBT or PBT blends. With regard to inorganic fibres, glass fibres are used for preference as these, in contrast to aramid or carbon fibres, can be separated relatively cheaply from the plastics matrix on recycling of the fibre-reinforced plastics article, and furthermore glass fibres are relatively cheap.

PBT fibres are characterised in that due to the production process these have a crystalline alignment in the fibre direction while the matrix between the fibres largely has no crystalline alignment i.e. is amorphous or of partly crystalline nature.

A plate according to the definition means a planar body with a certain bending stiffness and a thickness which in comparison with the length and width is substantially smaller. The plates which are produced according to the method of the invention continuously, i.e. endlessly, have for example a thickness of 1 mm or greater, preferably 3 mm or greater and in particular 5 mm or greater, and of 50 mm or smaller, preferably 20 mm or smaller and in particular 10 mm or smaller.

For execution of the method, a first web-like and preferably unfolded fibre structure is fed to a fibre laying device in the advance direction. By means of fibre feed units, in line one or more further web-like fibre structures are arranged over the first fibre structure. Before or after at least one, and preferably several, fibre feed units are provided matrix feed units by means of which a matrix starting material is supplied to exposed layers of fibre structures.

The multilayer fibre web which is guided through the fibre laying device and continuously coated with further fibre layers and/or matrix starting material, after conclusion of the coatings i.e. after emergence from the fibre-laying device, is supplied to a continuous press in which the matrix starting material is transformed under the effect of heat and/or pressure into a low viscosity fluid, and the multilayer fibre web under impregnation of the fibre structure is pressed into a plate-like material.

The fibre laying device and the continuous press are here arranged in-line. In-line means arranged in a (single) production line.

The fibre structures can be supplied dry or already pre-impregnated, in particular pre-impregnated with a binding agent. The composition of the pre-impregnation corresponds preferably to the matrix starting material supplied.

The matrix starting material is preferably by definition a reactive starting material. The reactive starting material contains in particular cyclic oligomers of PBT (CPBT) mixed with a polymerisation catalyst or comprising this.

The matrix starting material is applied e.g. in liquid form, as a foil or film and preferably in powder form onto the fibre lay(s). If the matrix starting material is applied in liquid form, this can be done by spraying, coating, casting, rolling or scraping. The matrix feed units are equipped accordingly. Furthermore, the matrix starting material can also be applied by impregnation of the fibre structures in a continuous immersion bath.

By heating of the fibre structure or fibre lay coated with the matrix starting material, in particular with powder or a film or foil, in the fibre laying device, due to the adhesive properties of the softened or melted starting material, the fibre structure or its fibres are glued together, wherein the polymerisation process need not necessarily be triggered but in a special embodiment of the invention can already begin.

The low viscosity properties of the matrix starting material which is used guarantee optimum saturation or impregnation of the fibres, which is of great importance in particular in plastics articles with a high fibre content in the form of dense fibre structures. The fibre content of the fibre-reinforced plastics panels which are produced with the method according to the invention is preferably more than 30 vol. % (volume percent), in particular more than 40 vol. % and preferably less than 80 vol. %, in particular less than 70 vol. % and advantageously less than 60 vol. %.

Polymerisation of the reactive matrix starting material into a thermoplastic plastics matrix, in particular a PBT plastics matrix, takes place fully or at least mainly in the continuous press.

According to a first specific embodiment of the invention, the matrix starting material in powder form is scattered by means of a powder scattering device onto the fibre structure.

According to a second specific embodiment of the invention the matrix starting material is applied to the fibre structure in the form of a foil or film.

The fibre laying device preferably contains one or more pressing stations arranged in-line, in particular impression cylinders, by means of which the multilayer fibre web can be pre-pressed in-line.

The said impression cylinders comprise a contact roller and an impression roller arranged in pairs, between which the multilayer fibre web is guided under pressure.

In a refinement of the invention the pressing station or impression cylinder is part of the fibre feed unit, where the contact roller serves simultaneously as transport roller by way of which a web-like fibre structure is supplied or deflected in the advance direction and applied to the fibre lay. The pressing station is preferably arranged in a fibre feed unit supplying the fibre structure unfolded in the advance direction.

In the refinement of the invention at least one fibre feed unit is designed as a cross layer by means of which a web-like flat structure, supplied obliquely or diagonally to the advance direction of the multilayer fibre web, by regular folding thereof along side edges, forming laying edges of the multilayer fibre web, is applied as multiple layers i.e. in particular as two layers with simultaneous advance on the fibre web. The fibre structure which is applied is preferably supplied at an angle of around 45° to the advance direction of the fibre lay and in each case laid at an angle of around 45° to the advance direction of the fibre lay. The web width of the obliquely supplied fibre structure here corresponds to the length of the edge line running obliquely over the fibre web from one laying edge to the opposite laying edge. Furthermore, the web width of the obliquely supplied fibre structure corresponds to the product b×√2 (square root of 2) where b is the width of the (multilayer) fibre web.

However, other feed and laying angles and other web widths can be selected. The fibre feed unit with cross layer here allows adjustment of the feed and laying angle.

The fibre structure is applied crossing by means of deflections in the cross layer in an alternating sideways movement i.e. a reciprocating movement in relation to the advance direction. Furthermore, the fibre structure can be applied crossing by means of deflection in the cross layer in a coil-like rotary movement. The multilayer fibre structures which are applied crossing can in some cases be fixed to each other or to other fibre structures in secondary stations by means of aids such as fibres, needles or threads.

If the fibre structures for example contain aligned fibres, in particular fibres aligned in one or two directions as is normal with woven structures, due the sectional laying of the fibre structures the fibre direction in the fibre web changes continuously, whereby the mechanical values are reinforced in several directions.

In a refinement of the invention, a web-like unfolded fibre structure is supplied in the advance direction of the fibre lay and alternately a secondary web-like fibre structure, folded crossways, is supplied obliquely or diagonally to the advance direction of the fibre lay. The fibre structure forming the first final fibre cover layer of the multilayer fibre web and the fibre structure forming the second final fibre cover layer of the multilayer fibre web are preferably unfolded and supplied in the advance direction of the multilayer fibre web. The two fibre structures are supplied accordingly with the first and last fibre feed unit of the fibre laying device.

For the purpose of supplying the matrix starting material, preferably at least after each fibre feed unit with cross layer is arranged a matrix feed unit, in particular a powder scatterer. However, each fibre feed unit can also be followed by a matrix feed unit, in particular a powder scatterer. In the preferred embodiment of the invention, in particular between the last fibre feed unit and the continuous press, is arranged a last matrix feed unit, in particular a powder scatterer.

The number of fibre layers and the quantity of the matrix starting material which are used determines the achievable thickness of the multilayer fibre web and hence the plate material to be produced and its fibre content. The individually applied fibre structures can have structures which deviate from each other. Thus for example alternate layers of fibre fleece and fibre weave can be provided.

The multilayer fibre web in a preferred embodiment of the invention is coated, after the supply of all fibre structures and all matrix starting material and before entering the continuous press, on one or both sides with a cover layer in the form of a plastic film or extruded plastic film by means of a film feed device. In the secondary continuous press, the cover layer thus connects with the polymerising plastics matrix of the multilayer fibre web. The cover layer is then an integral part of the fibre-reinforced plate material to be produced.

The cover layer is preferably made of polymerised thermoplastic plastics, preferably a (polymerised) polyester such as PET, in particular a PBT or PBT plastic alloy. The cover layers and plastics matrix of the multilayer fibre web in the polymerised state can comprise the same plastics or similar plastics alloys.

The cover layer which is applied to the fibre web can also be a fibre-reinforced web-like plastics material with an outer, exposed, fibre-free (polymerised) plastics layer of the composition given above.

The said cover layer for example has a thickness of more than 50 μm, in particular more than 100 μm and less than 2000 μm, in particular less than 1000 μm.

Thanks to the sticky properties of the reactive starting material, the plastics film preferably remains glued to the impregnated or coated multilayer fibre web.

The melt or decomposition point of the cover layers is here higher than the polymerisation temperature of the reactive starting material. Thus the cover layer is not harmed during the polymerisation process of the plastics matrix.

Since the melt point of the PBT cover layer which is already polymerised (approx 220° C.) is higher than the polymerisation temperature of the reactive starting material which is used (approx 180° C.-190° C.), the cover layer of PBT is not disadvantageously harmed by the effect of heat on polymerisation of the plastics matrix.

The integral application of the said cover layers has the advantage that a high surface quality of the plate material is achieved as the cover layers contain no fibres. Furthermore, the cover layers at the same time serve as release layers (separating layers) which prevent the impregnated multilayer fibre web from adhering to the device parts which are in contact therewith, such as rollers or pressing plates, and hence their soiling.

In one embodiment of the invention the cover layers can be dyed and thus already give the plate material its external colour appearance. The dyeing can be such that the fibre-reinforced layers which are arranged below the cover layers are no longer visible. As a result, where applicable a subsequent paint application layer can be omitted.

The multilayer fibre web which is present in the form of a material laminate is formed in the continuous press under the supply of heat and/or pressure with polymerisation of the plastics matrix into a polyester, in particular into a PBT internally, and preferably pore-free into a plate-like material.

The multilayer fibre web in the continuous press is preferably guided through several separately adjustable pressing zones and tempering zones, where the contact pressures are generated by floating, hydraulically activated lower pressing plates which work against an upper, rigid press construction. The pressure in the continuous press is created in particular by way of segmented pressing plates with adjustable gap intervals from each other. Floating of the fibre web is prevented by the gap openings between adjacent pressing segments.

In a preferred embodiment, after a particular number of segmented pressing plates is arranged an additional pressing station, in particular an impression cylinder, which exerts a linear pressure on the impregnated fibre lay. By exerting a linear pressure any bubbles and pinholes present in the plastics matrix are expelled. The continuous press can have one or more pressing stations, in particular impression cylinders, arranged after the pressing plates so that the fibre web undergoes a complete and bubble-free impregnation of the fibre structure with the melt-fluid plastics matrix.

The fibre lay or plate material in the continuous press is advanced preferably by means of a double belt system.

The finished plate material after leaving the continuous press can be supplied on a roller conveyor to a cutting or sawing device and cut or trimmed longitudinally and/or transversely to the throughput direction or advance direction into individual plates or strips and stacked in batches.

The device for performance of the method according to the invention, as already stated, contains a fibre laying device and following this in-line a continuous press. The fibre laying device contains several fibre feed units for in-line supply of web-like fibre structures and one or more matrix feed units connected between or after the fibre feed units to supply a matrix starting material onto exposed layers of fibre structures.

The matrix feed unit is for example a powder scatterer by means of which the matrix starting material which is present in powder form is scattered, in each case on a layer of an exposed fibre structure. The matrix feed unit can also be a film supply device by means of which a film-like matrix starting material is applied to an exposed layer of a fibre structure.

The fibre laying device preferably contains one or more pressing stations, in particular impression cylinders, by means of which the multilayer web-like fibre lay can be pre-pressed in-line. The pressing station preferably contains a contact roller and an impression roller arranged in pairs, between which the web-like fibre lay is guided. The pressing station is preferably part of a fibre feed unit, in particular to feed the fibre structure in the advance direction, the contact roller serving simultaneously as a transport roller to supply the web-like fibre structure.

At least one fibre feed unit of the fibre lay device is designed as a cross layer. In a preferred embodiment of the invention the fibre laying device alternately comprises a fibre feed unit for the supply of web-like fibre structures in the advance direction of the fibre lay and a subsequent fibre feed unit with cross layer.

Preferably, at least following a fibre feed unit with cross layer are arranged matrix feed units. The matrix feed units can also be arranged after any fibre feed unit.

The continuous press preferably contains several separately adjustable pressing and tempering zones, where the pressing zones, to exert the pressure, contain floating hydraulically activated lower pressing plates which work against an upper rigid press construction. The pressing zones have in particular a multiplicity of segmented pressing plates with adjustable gap spacing to each other. The gap openings form for example an air gap of 1 to 10 mm, in particular 3 to 5 mm.

In a refinement of the invention, after a certain number of segmented pressing plates is arranged a pressing station, preferably a design of an impression cylinder to generate a linear pressure. The continuous press can contain one or more such pressing stations.

The continuous press is preferably operated by means of a double belt system. The associated belts can be PTFE (polytetrafluoroethylene) belts or steel belts. This construction depending on the length of the heating section allows medium to high throughputs.

The method according to the invention allows the continuous production of fibre-reinforced endless plate material with thermoplastic plastics matrix, which allows a fully automated production operation from the supply of the fibre structure and matrix starting material through to the trimming of the finished plate material after emergence from the continuous press.

The fibre-reinforced plate material according to the invention is used as flat panel or strip goods. Furthermore, the plate material can be processed further into thermally formed three-dimensional articles e.g. by means of thermal deep drawing. Furthermore, the said plate material can be processed further in the form of flat panels into multilayer laminates i.e. containing several further layers, in particular for sandwich constructions, where the further layers can comprise foams, metal foil or metal plates.

The said plate material or composite plates formed from this or thermoformed articles are used in the transport industry such as road vehicle construction (cars, buses, trucks, vans etc), rail vehicle construction (rail vehicles, trams, high speed trains, maglev trains), aviation (aircraft construction, space travel), ship or boat construction or in cable cars. Furthermore, the said plate material can be used in construction and civil engineering, interior construction and in particular in building technology and in the production of sports equipment.

From the plate material according to the invention for example can be made body trim panels, underfloor trays, structure profiles, trim strips etc., trim elements, panels etc.

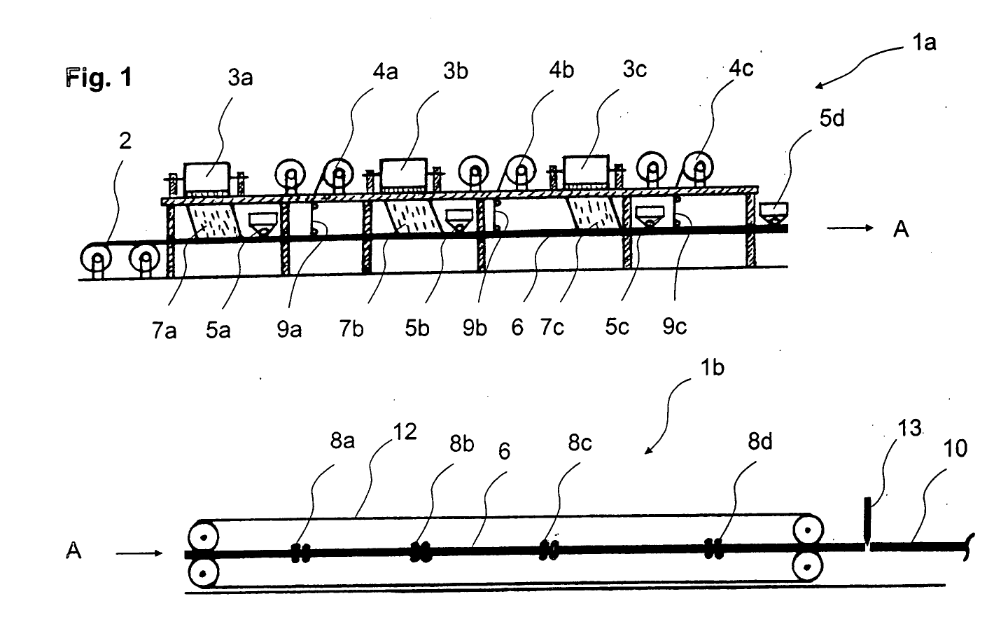

FIG. 1 shows a device 1a, 1b for continuous production of a fibre-reinforced plate material. A first web-like fibre structure 2 is supplied unfolded in the feed direction to the device 1a. Over the fibre structure 2 is applied, by means of a cross layer 3a, a further fibre structure 7a obliquely/diagonally, transversely from laying edge to laying edge. By means of powder scatterer 5a, in-line and continuously, powdery matrix starting material is applied evenly onto the exposed surface of the fibre web 6. Over the fibre web 6 which is coated with the matrix starting material, by way of a fibre feed unit 4a in the advance direction, is supplied a further unfolded web-like fibre structure 9a and laid over the transversely arranged fibre structure 7a. The web-like fibre structure 9a is pressed by means of an impression cylinder onto the multilayer fibre web 6 and connects to the powder-coated fibre structure 7a below. By way of a further cross layer 3b a further web-like fibre structure 7b is applied obliquely/diagonally onto the multilayer fibre web 6 transversely from laying edge to laying edge, and by means of powder scatterer 5b again coated with powdery matrix starting material. Over the fibre structure 7b which is coated with the matrix starting material, by way of a fibre feed unit 4b in the advance direction, is supplied a further unfolded web-like fibre structure 9b which is laid over the transversely arranged fibre structure 7b. The web-like fibre structure 9b is again pressed onto the multilayer fibre web 6 by an impression cylinder and connects to the powder-coated fibre structure 7b below.

By way of a further cross layer 3c a web-like fibre structure 7c is again applied onto the multilayer fibre web 6 obliquely/diagonally, folded cross-ways from laying edge to laying edge, and by means of powder scatterer 5c again coated with powdery matrix starting material. Over the fibre structure 7c which is coated with the matrix starting material, by way of a fibre feed unit 4c in the advance direction, is supplied a final unfolded web-like fibre structure 9c which is laid over the cross-ways arranged fibre structure 7c. The web-like fibre structure 9c is here pressed by an impression cylinder onto the fibre structure 6 and connects to the powder-coated fibre structure 7c below. Before entering the continuous press a final powder scatterer 5d is provided which coats the exposed surface of the multilayer fibre web 6 with powdery matrix starting material.

The fibre structure 6 which is coated with the matrix starting material is supplied in-line (see continuation arrow A) to a continuous press 1b in which the continuously supplied multilayer fibre web is pressed into a plate material in several pressing zones with segmented pressing plates. Between the pressing plates are arranged impression cylinders 8a, b, c to generate a linear pressure.

The advance of the fibre lay in the continuous press is here guaranteed by a double belt conveyor unit 12. On emergence of the plate material from the continuous press this is trimmed into individual plates 10 by means of cutting or sawing device 13.

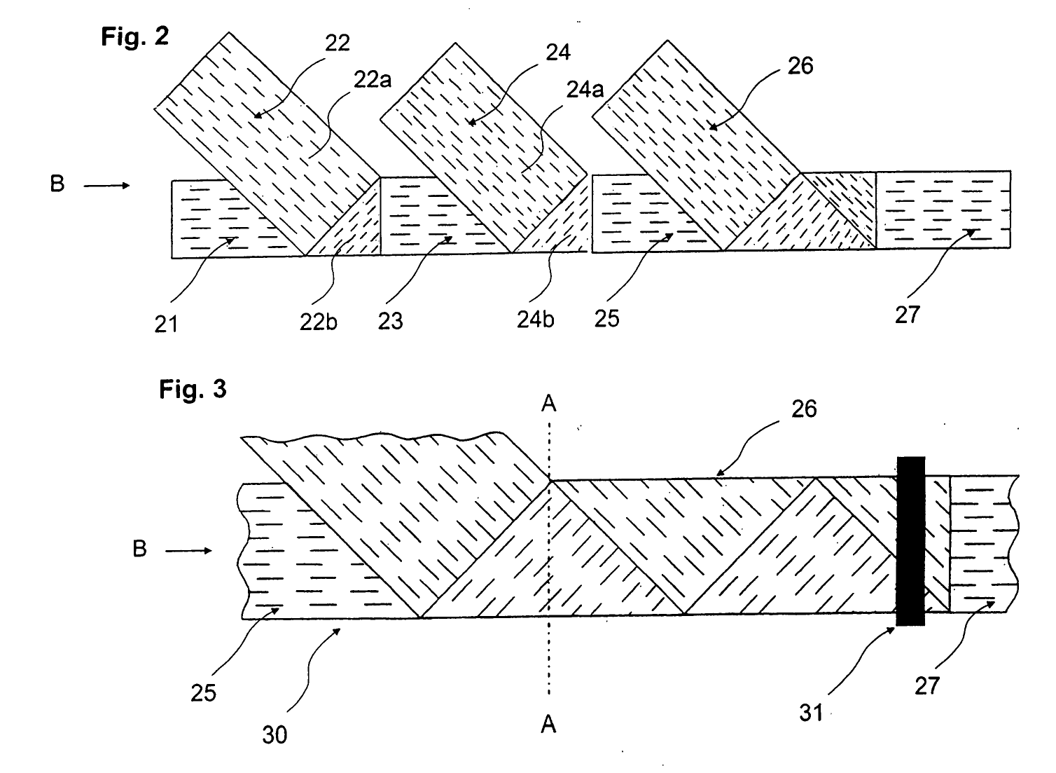

FIG. 2 shows a possible structure of a plate material which is produced according to the method of the invention. Arrow B shows the advance direction of the multilayer fibre web in the device.

The fibre lay contains a first fibre structure 21 which was supplied first, unfolded, in the advance direction of the device. The second fibre structure 22 is laid onto the first fibre structure 21 cross-ways by means of cross layer at an angle of 45° obliquely/diagonally to the advance direction and folded into an upper fibre layer 22b and a lower fibre layer 22a. Over the folded applied fibre lay 22 is in turn laid an unfolded fibre structure 23 which is supplied unfolded in the advance direction.

The next layer is again a fibre structure 24 applied obliquely/diagonally crossed by means of a cross layer at a 45° angle to the advance direction, with an upper fibre layer 24b and below this a fibre layer 24a. Over these fibre layers, similar to the above-mentioned laying pattern, are applied fibre structures 25 and 26 and finally an unfolded fibre layer 27 which is also supplied in the advance direction.

FIG. 3 shows an extract from a multilayer fibre web 30 with a lower and an upper unfolded fibre structure 25, 27 and arranged between these two fibre structures a fibre structure 26 which is applied by means of cross layer. A powder scatterer 31 is applied over the cross-ways laid fibre structure 26 and coats this with powdery matrix starting material. Then the next unfolded fibre layer 27 is applied.

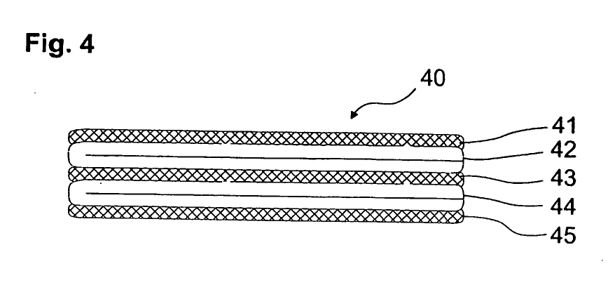

FIG. 4 shows a diagrammatic cross-section A-A through a fibre lay according to FIG. 3 with alternate layers of fibre structures 42, 44 folded cross-ways and accordingly in two layers, and between these the unfolded fibre structures 41, 43, 45 which are applied in the advance direction.

1-32. (canceled)

33. Method for continuous production of a thermoplastic plate material reinforced with flat fibre structures, in which method a first web-like fibre structure is supplied to a fibre laying device, by means of in-line fibre feed units one or more further web-like fibre structures are arranged over the first fibre structure, by means of one or more matrix feed units connected before or after the fibre feed units a matrix starting material is supplied to exposed layers of fibre structures, and the multilayer fibre web emerging from the fibre laying device and coated one or more times with intermediate layers of matrix starting material is supplied to a continuous press in which the matrix starting material is transformed under the effect of heat and/or pressure into a low viscosity fluid and the multilayer fibre web under impregnation of the fibre structure is pressed into a plate-like plastics material, wherein at least one fibre feed unit is formed as a cross layer by means of which a web-like flat structure which is supplied obliquely or diagonally to the advance direction of the fibre web is applied to the fibre web by regular folding thereof along the side edges of the fibre web.

34. Method according to claim 33, wherein the web-like surface structure is supplied and folded at an angle of 45° to the advance direction of the fibre web.

35. Method according to claim 33, wherein alternately a web-like fibre structure is supplied unfolded in the advance direction of the fibre web and a subsequent web-like fibre structure is supplied by means of cross layers crossing obliquely or diagonally to the feed direction of the fibre web, where the first and last fibre structures which are supplied are supplied preferably unfolded in the advance direction of the fibre web

36. Method according to claim 33, wherein the matrix feed units are in each case arranged after a fibre feed unit with cross layer.

37. Method according to claim 33, wherein the matrix starting material is a reactive starting material containing cyclic or macrocyclic oligomers of polyester mixed with a polymerisation catalyst, in particular a reactive starting material containing cyclic oligomers of PBT (CPBT) mixed with a polymerisation catalyst.

38. Method according to claim 33, wherein the matrix feed units are powder scatterers by means of which the matrix starting material which is present in powder form is scattered onto a layer of an exposed fibre structure.

39. Method according to claim 33, wherein, by means of matrix feed supply units, a film-like matrix starting material is applied to the exposed surface of a fibre structure.

40. Method according to claim 33, wherein the reactive starting material is polymerised in the continuous press into a thermoplastic plastics matrix.

41. Method according to claim 33, wherein the fibre laying device contains one or more pressing stations by means of which the multilayer fibre web is pre-pressed in-line.

42. Method according to claim 41, wherein the pressing station comprises a contact roller and impression roller arranged in pairs, between which the web-like fibre lay is supplied during a pressing process.

43. Method according to claim 42, wherein the pressing station is part of a fibre feed unit, where by way of the contact roller a web-like fibre structure is simultaneously supplied, deflected and applied to the fibre web.

44. Method according to claim 33, wherein the further fibre structures which are supplied by way of a fibre feed unit in the advance direction of the fibre web are applied by way of a pressing station onto the multilayer fibre web.

45. Method according to claim 33, wherein the multilayer fibre web, after supply of all fibre structures and all matrix starting materials and before entry into the continuous press, is coated on one or both sides with a cover layer in the form of a plastics foil or extruded plastics film, where in the continuous press the cover layer connects to the plastics matrix of the multilayer fibre web.

46. Method according to claim 33, wherein the cover layer comprises thermoplastic plastics.

47. Method according to claim 33, wherein the multilayer fibre web which is present in the form of a material laminate, in the continuous press under the supply of heat and/or pressure and under polymerisation of the plastics matrix, is connected into a thermoplastic plastics internally and pore-free into a plate-like plastics material.

48. Method according to claim 33, wherein the multilayer fibre web is guided through a continuous press with several separately adjustable pressing zones and tempering zones and the contact pressures are generated by floating hydraulically activated lower pressing plates which work against an upper rigid pressing construction.

49. Method according to claim 48, wherein the pressure in the continuous press is created by segmented pressure plates with adjustable gap spacing to each other.

50. Method according to claim 49, wherein after a particular number of segmented pressing plates, a line pressure is generated to expel pinholes and bubbles from the plastics matrix, in each case by means of an impression cylinder.

51. Method according to claim 33, wherein the multilayer fibre web is guided through one or more impression cylinders which are arranged in the continuous press, whereby the multilayer fibre web undergoes a complete bubble-free impregnation of the fibre structure with the melt-like plastics matrix.

52. Device for performance of the method according to claim 33, wherein the device comprises a fibre laying device and following this in-line a continuous press, and the fibre laying device contains several fibre feed units for in-line supply of web-like fibre structures and one or more matrix feed units connected between or after the fibre feed units for the supply of the matrix starting material onto exposed layers of the fibre structure, characterised in that at least one fibre feed unit is formed as a cross layer, by means of which a web-like fibre structure can be supplied obliquely or diagonally in the advance direction of the multilayer fibre web and folded to form laying edges.

53. Device according to claim 52, wherein alternately a fibre feed unit for unfolded supply of a web-like fibre structure in the advance direction of the fibre web and a subsequent fibre feed unit with cross layer for the supply of a web-like fibre structure obliquely or diagonally to the advance direction of the fibre web is present, characterised in that the first and last fibre feed unit is for unfolded supply of a web-like fibre structure in the advance direction of the fibre web.

54. Device according to claim 52, wherein after a fibre feed unit with cross layer is arranged a matrix feed unit.

55. Device according to claim 54, wherein the matrix feed unit is a powder scatterer by means of which a matrix starting material which is present in powder form is scattered onto exposed layers of the fibre structure.

56. Device according to claim 54, wherein the matrix feed unit is a film feed unit by means of which a film-like matrix starting material is applied to exposed layers of the fibre structure.

57. Device according to claim 52, wherein the fibre laying device contains one or more pressing stations, in particular impression cylinders, by means of which the multilayer fibre web is pre-pressed in-line.

58. Device according to claim 52, wherein the pressing station comprises a contact roller and an impression roller arranged in pairs and between which the multilayer fibre web is passed under a pressure.

59. Device according to claim 52, wherein the pressing station is part of a fibre feed unit and the contact roller serves simultaneously for unfolded feed and deflection of a web-like fibre structure in the advance direction.

60. Device according to claim 52, wherein the continuous press contains several separately adjustable pressing zones and tempering zones and the pressing zones, to exert the pressure, contain floating hydraulically activated lower pressing plates which work against an upper rigid pressing construction.

61. Device according to claim 52, wherein the pressing zones have segmented pressing plates with adjustable gap spacing to each other.

62. Device according to claim 52, wherein after every particular number of segmented pressing plates is arranged a pressing station, in particular an impression cylinder, to generate a linear pressure.
